(19) United States
(12) Patent Application Publication
(10) Pub. No.: US 2023/0065074 A1
(43) Pub. Date: Mar. 2, 2023

(54) COUNTERFEIT OBJECT DETECTION USING IMAGE ANALYSIS

(71) Applicant: Capital One Services, LLC, McLean, VA (US)

(72) Inventors: Galen RAFFERTY, Mahomet, IL (US); Austin WALTERS, Savoy, IL (US); Grant EDEN, Menlo Park, CA (US); Anh TRUONG, Champaign, IL (US); Christopher WALLACE, Rochester, NY (US); Samuel SHARPE, Cambridge, MA (US); Brian BARR, Schenectady, NY (US)

(21) Appl. No.: 17/446,689

(22) Filed: Sep. 1, 2021

(51) Int. Cl. G06F 40/295; G06K 9/20; G06N 20/20; G06F 16/908

(52) U.S. Cl. CPC G06F 40/295; G06K 9/2054; G06N 20/20; G06F 16/908; G06K 2209/01

(57) ABSTRACT

A system may receive user interface information that indicates an image, associated with a web page, that depicts an object for which a counterfeit estimation is to be determined, text associated with the web page, or an entity identifier that identifies an entity associated with the web page and the object. The system may determine a first estimation that the object is counterfeit based on performing an image analysis of the image, a second estimation that the object is counterfeit based on performing text analysis of the text, or a third estimation that the object is counterfeit based on performing an entity analysis of the entity. The system may determine the counterfeit estimation based on the first estimation, the second estimation, or the third estimation. The counterfeit estimation may indicate a likelihood that the object is counterfeit. The system may transmit information that identifies the counterfeit estimation.

### BACKGROUND

Image analysis is the extraction of meaningful information from images, such as the extraction of information from digital images using digital image processing techniques. Digital image analysis or computer image analysis uses a computer or electrical device to study an image to obtain useful information from the image. Image analysis can involve computer vision or machine vision, and may use pattern recognition, digital geometry, and signal processing. Image analysis may be used for two-dimensional and three-dimensional digital images.

### SUMMARY

Some implementations described herein relate to a system for using image analysis to detect counterfeit objects. The system may include one or more memories and one or more processors communicatively coupled to the one or more memories. The one or more processors may be configured to receive, from a client device, user interface information that indicates an image of an object for which a counterfeit estimation is to be determined. The one or more processors may be configured to perform an image analysis on the image. The image analysis may include at least one of a comparison of the image and one or more other images obtained from a web search associated with the object or a comparison of one or more features of the object, recognized from the image, to one or more features of an authentic object corresponding to the object. The one or more processors may be configured to determine the counterfeit estimation based on performing the image analysis, wherein the counterfeit estimation indicates a likelihood that the object is counterfeit. The one or more processors may be configured to transmit, to the client device, information that identifies the counterfeit estimation.

Some implementations described herein relate to a method for detecting counterfeit objects. The method may include receiving, by a system, user interface information that indicates at least one of an image, associated with a web page, that depicts an object for which a counterfeit estimation is to be determined, text associated with the web page, or an entity identifier that identifies an entity associated with the web page and the object. The method may include determining, by the system, at least one of a first estimation that the object is counterfeit based on performing an image analysis of the image, a second estimation that the object is counterfeit based on performing text analysis of the text, or a third estimation that the object is counterfeit based on performing an entity analysis of the entity. The method may include determining, by the system, the counterfeit estimation based on at least one of the first estimation, the second estimation, or the third estimation, wherein the counterfeit estimation indicates a likelihood that the object is counterfeit. The method may include transmitting, by the system and to a client device, information that identifies the counterfeit estimation.

Some implementations described herein relate to a non-transitory computer-readable medium that stores a set of instructions for triggering a counterfeit estimation and presenting the counterfeit estimation via a user interface for a client device. The set of instructions, when executed by one or more processors of the client device, may cause the client device to detect that the user interface, to be provided for presentation by the client device, is associated with an object for which the counterfeit estimation is to be determined. The set of instructions, when executed by one or more processors of the client device, may cause the client device to transmit, to a server, user interface information that indicates at least two of text of a web page associated with the object, one or more images, of the web page, that depict the object, or an entity identifier for an entity associated with the object. The set of instructions, when executed by one or more processors of the client device, may cause the client device to receive, from the server, presentation information that includes a counterfeit estimation for the object based on transmitting the user interface information, wherein the counterfeit estimation indicates a likelihood that the object is counterfeit. The set of instructions, when executed by one or more processors of the client device, may cause the client device to insert code into a document object model of the user interface based on the presentation information, wherein the code causes the counterfeit estimation to be provided for presentation via the user interface. The set of instructions, when executed by one or more processors of the client device, may cause the client device to provide the user interface for presentation by the client device based on inserting the code into the document object model.

### BRIEF DESCRIPTION OF THE DRAWINGS

FIGS. 1A-1C are diagrams of an example implementation relating to counterfeit object detection.

FIG. 2 is a diagram illustrating an example of training and using a machine learning model in connection with counterfeit object detection.

FIG. 3 is a diagram of an example environment in which systems and/or methods described herein may be implemented.

FIG. 4 is a diagram of example components of one or more devices of FIG. 3.

FIGS. 5 and 6 are flowcharts of example processes relating to counterfeit object detection.

### DETAILED DESCRIPTION

The following detailed description of example implementations refers to the accompanying drawings. The same reference numbers in different drawings may identify the same or similar elements.

Counterfeit objects may look similar to legitimate objects, which can make detecting counterfeit objects difficult. Computers may be used to assist with counterfeit object detection, such as by using image analysis to analyze an image of an object to determine whether the object is counterfeit or legitimate. Such computer-based analysis of objects can improve the reliability with which counterfeit objects can be detected. Some techniques described herein improve the accuracy and reliability of counterfeit object detection using image analysis, among other counterfeit object detection techniques.

Furthermore, some techniques described herein further improve the accuracy and reliability of counterfeit object detection by using context associated with an image of an object. For example, if the image of the object appears on a web page, techniques described herein may analyze text of the web page or other information associated with the web page to improve the accuracy and reliability of counterfeit object detection (e.g., regardless of whether image analysis is also used). Also, some techniques described herein use machine learning to improve the accuracy and reliability of counterfeit object detection.

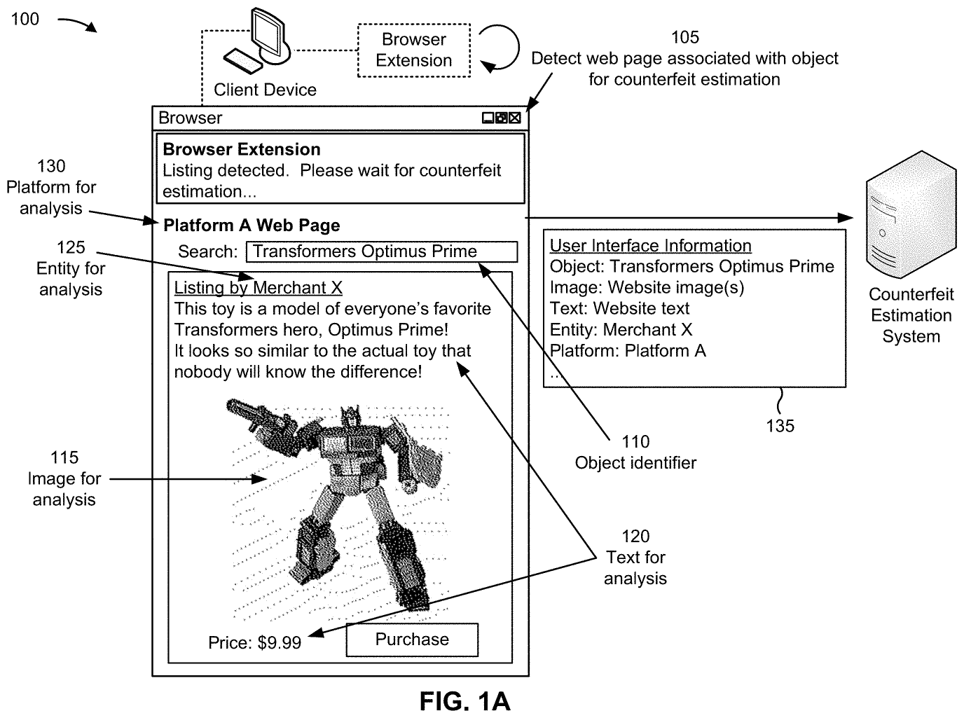

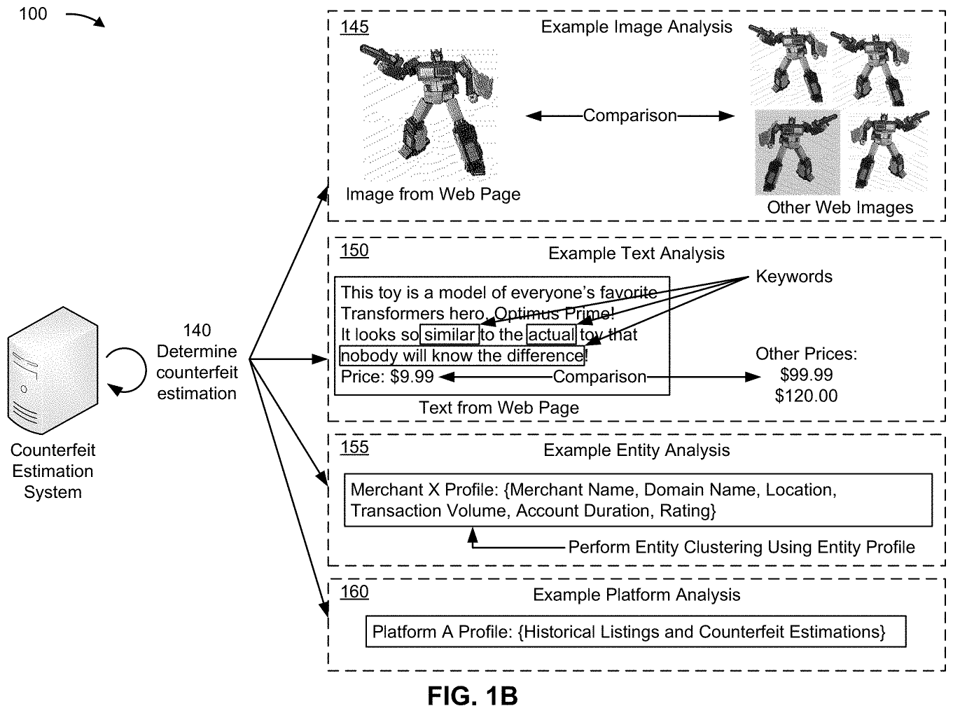

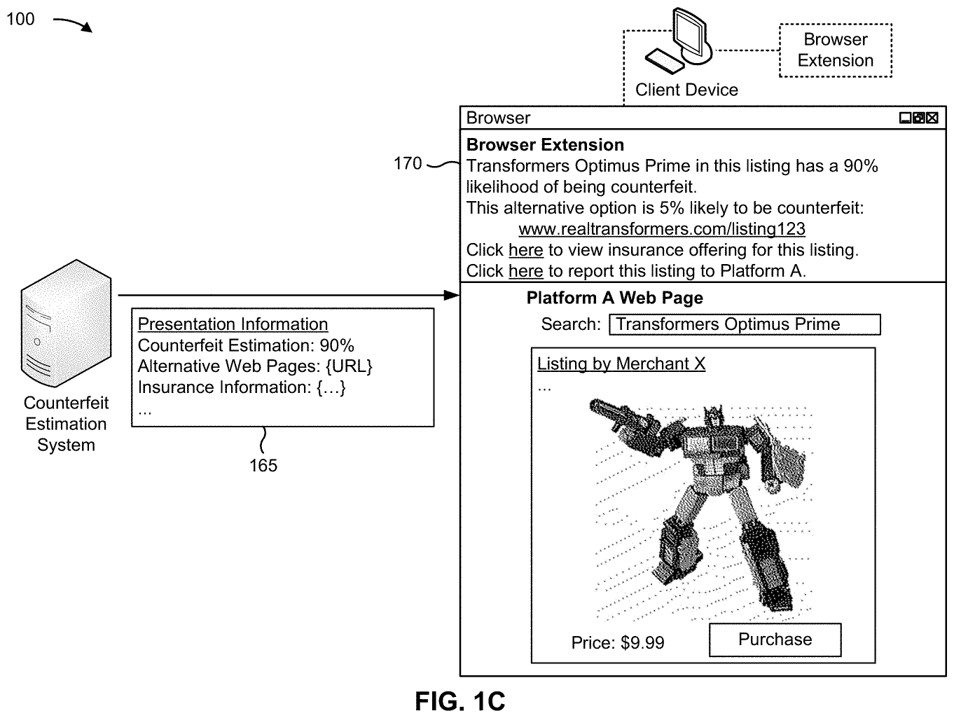

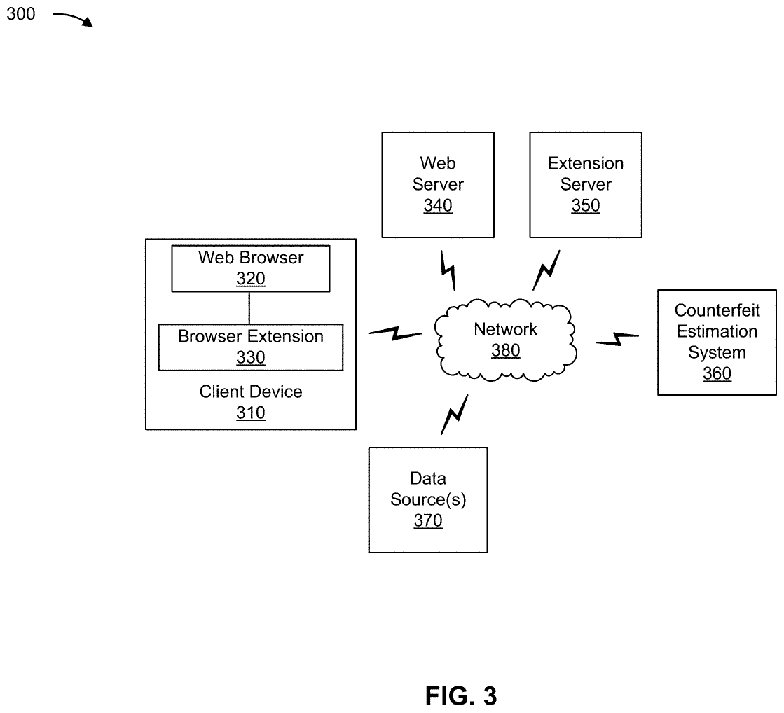

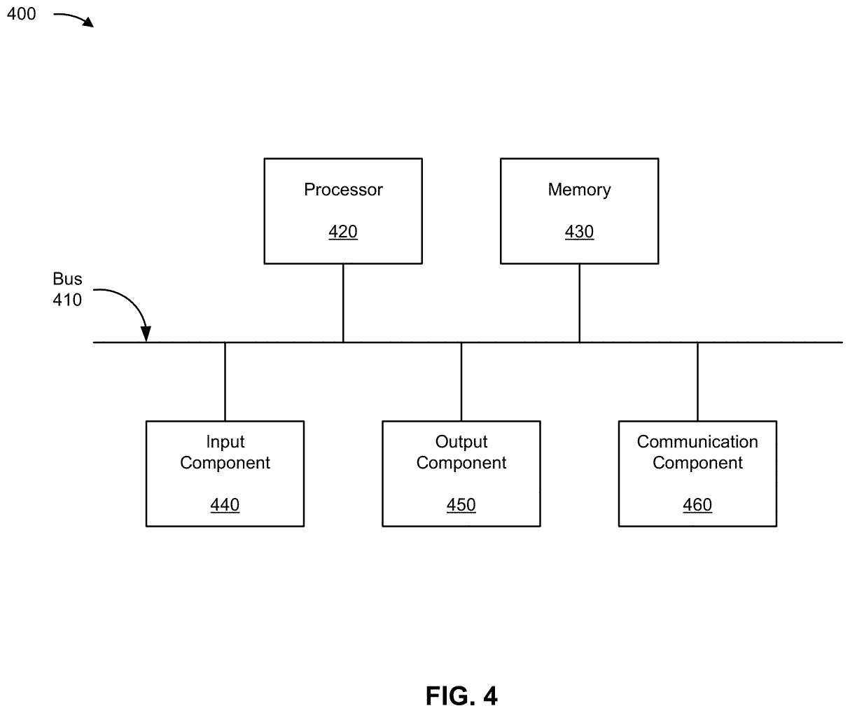

FIGS. 1A-1C are diagrams of an example 100 associated with counterfeit object detection. As shown in FIGS. 1A-1C, example 100 includes a client device and a counterfeit estimation system. In some implementations, the client device may execute a browser extension, as shown. The client device, the counterfeit estimation system, and the browser extension are described in more detail in connection with FIGS. 3 and 4.

As shown in FIG. 1A, and by reference number 105, the client device (e.g., the browser extension executing on the client device) may detect that a web page (or another type of user interface, such as a user interface of an application), to be provided for presentation by the client device, is associated with an object for which a counterfeit estimation is to be determined. For example, a user may interact with a web browser to navigate to a web page, such as by clicking a link or otherwise inputting a uniform resource locator (URL). The client device may request web page information (e.g., HyperText Markup Language (HTML) code, one or more images, or the like) from a web server that serves the web page. The web server may transmit the web page information to the client device for presentation by the client device (e.g., in the web browser). The client device (e.g., using the browser extension) may analyze the web page information and/or the URL to determine whether the web page is associated with an object for counterfeit estimation.

In some implementations, the client device may determine whether the web page is associated with an object for counterfeit estimation based on the URL of the web page. For example, the client device may determine whether the URL or a portion of the URL (e.g., a domain name, a subdomain, and/or a page path) includes one or more strings (e.g., a sequence of characters, such as a keyword), which may be stored in memory of the client device and/or obtained from an extension server associated with the browser extension. If the URL includes the one or more strings, then the client device may determine that the web page is associated with an object for counterfeit estimation, and may proceed to transmit user interface information to the counterfeit estimation system for counterfeit estimation, as described in more detail below. If the URL does not include the one or more strings, then the client device may refrain from transmitting the user interface information to the counterfeit estimation system to conserve computing resources (e.g., processing resources and/or memory resources) and to conserve network resources that would otherwise be used to transmit the user interface information.

In some implementations, the client device and/or the extension server may store different sets of strings for different domain names. For example, different retailers that have different domain names may use different strings in a URL to indicate a listing page where an object is offered for sale. In this case, the client device may identify a set of strings based on the domain name, and may determine whether any string, included in the identified set of strings, is included in the URL to determine whether the web page is associated with an object for counterfeit estimation. In some implementations, the client device may transmit the domain name to an extension server, which may use the domain name to identify the set of strings and transmit the identified set of strings to the client device.

Additionally, or alternatively, the client device may determine whether the web page is associated with an object for counterfeit estimation based on user interface information, such as information that appears on the web page or that is represented by code of the web page. The user interface information may include, for example, text of the web page, an image presented on the web page, or image metadata associated with the image, among other examples. For example, the client device may determine whether the text or image metadata includes one or more strings (e.g., keywords), which may be stored in memory of the client device and/or obtained from an extension server associated with the browser extension. If the text and/or image metadata includes the one or more strings, then the client device may determine that the web page is associated with an object for counterfeit estimation, and may proceed to transmit user interface information to the counterfeit estimation system for counterfeit estimation, as described in more detail below. If the text and/or image metadata does not include the one or more strings, then the client device may refrain from transmitting the user interface information to the counterfeit estimation system to conserve computing resources (e.g., processing resources and/or memory resources) and to conserve network resources that would otherwise be used to transmit the user interface information. In some implementations, the one or more strings may be indicative of an offer for sale of the object, such as a keyword of “sale,” “price,” “purchase,” or the like.

As shown in FIG. 1A, the user interface information may include, for example, an object identifier 110, an image 115, text 120, information that identifies an entity 125 (e.g., a merchant), and/or information that identifies a platform 130 (e.g., a web platform or web domain). As an example, the web page may include a listing of an object for sale. The object may be identified by the object identifier 110, such as text of a search query performed to return one or more search results that include the web page, a stock-keeping unit (SKU) associated with the object, and/or a portion of a URL that indicates the object. The image 115 may include an image that appears on the web page and/or that is indicated in HTML, code or other code of the web page. The image 115 may depict the object for which counterfeit estimation is to be performed. In some implementations, the client device may identify an image of the object based on the image appearing in a predetermined location on the web page (e.g., as indicated by HTML code), based on the image being marked with a particular indication in the code, based on the image being associated with and/or tagged with particular metadata, and/or based on discarding one or more images that are known to not be associated with an object for sale (e.g., an image of a merchant logo, an image of a domain logo, an image of a platform logo, an image of a button or other input element, or the like). Although a single image is shown in FIG. 1A, in some aspects, multiple images may be included in the user interface information and may be analyzed.

The text 120 may include any text that appears on the web page or that is indicated in the web page code (e.g., HTML, code). As shown in FIG. 1A, the text 120 may include a description of the object, text associated with a listing of the object for sale, and/or text that indicates a price of the object, among other examples. The entity 125 may include an entity associated with the object and/or the web page, such as a merchant that offers the object for sale via the web page. In some implementations, the entity 125 may be identified by the client device and/or the counterfeit estimation system based on the text 120 and/or the URL of the web page. For example, the text 120 and/or the URL may include an entity identifier that identifies the entity, such as an entity name (e.g., a merchant name) or an entity code (e.g., a merchant code). In some implementations, the entity identifier may appear at a particular location on the web page and/or in the web page code, or may be marked or tagged in the web page code to assist with identification.

The platform 130 may include a marketplace or other commercial platform via which the object is offered for sale, such as a domain, a retailer, a website, or the like. In some implementations, the platform 130 may be identified by the client device and/or the counterfeit estimation system based on the text 120 and/or the URL of the web page. For example, the text 120 and/or the URL may include a platform identifier that identifies the platform, such as a platform name (e.g., a retailer name), a domain name, or a platform code (e.g., a retailer code). In some implementations, the platform identifier may appear at a particular location on the web page and/or in the web page code, or may be marked or tagged in the web page code to assist with identification.

As shown by reference number 135, the client device may transmit, to the counterfeit estimation system, user interface information that assists with counterfeit object estimation (sometimes called counterfeit object detection). The user interface information may include one or more user interface elements described above, such as the object identifier 110, one or more images 115, text 120, information that identifies the entity 125 (e.g., an entity identifier), and/or information that identifies the platform 130 (e.g., a platform identifier). In some implementations, the user interface information may include at least two user interface elements (e.g., an image 115 and text 120, an image 115 and an entity identifier, text 120 and an entity identifier, or another combination) or at least three user interface elements (e.g., an image 115, text 120, and an entity identifier, among other possible combinations). In example 100 of FIG. 1A, the user interface information includes an object identifier 110 of “Transformers Optimus Prime,” the image 115 shown in FIG. 1A (which may be transmitted as image data used to present the image), the text 120 presented on the web page, an entity identifier of “Merchant X,” and a platform identifier of “Platform A.”

In some implementations, rather than the client device transmitting the user interface information to the counterfeit estimation system, the client device may transmit a URL of the web page to the counterfeit estimation system. The counterfeit estimation system may use the URL to obtain the user interface information from a web server that hosts the web page and that is accessible via the URL. In this way, computing resources of the client device may be conserved. Furthermore, this may lead to faster analysis in some cases because the counterfeit estimation system may have more available computing resources (e.g., more processing power and/or memory resources) than the client device to obtain the user interface information.

As shown in FIG. 1B, and by reference number 140, after receiving the user interface information (e.g., from the client device or the web server), the counterfeit estimation system may determine a counterfeit estimation for the object. The counterfeit estimation may indicate a likelihood that the object is counterfeit. To perform the counterfeit estimation, the counterfeit estimation system may perform one or more counterfeit estimation analyses, such as an image analysis, a text analysis, an entity analysis, and/or a platform analysis. In some implementations, the counterfeit estimation system may perform two or more of these counterfeit estimation analyses, three or more of these counterfeit estimation analyses, or all four of these counterfeit estimation analyses.

As shown by reference number 145, the image analysis may include a comparison of the image from the web page and one or more other images obtained from a web search associated with the object. For example, the counterfeit estimation system may perform a web search, such as an image search, using the object identifier (e.g., “Transformers Optimus Prime”), and may identify one or more images based on performing the web search. If the image from the web page matches an image identified based on performing the web search (e.g., an image other than the image from the web page, which may be determined based on a URL associated with the image), or if the image from the web page matches a threshold quantity of images identified based on performing the web search, then the counterfeit estimation system may set a counterfeit score to a high value, indicative of a high likelihood that the object is counterfeit because the image from the web page may have been found elsewhere on the web rather than being an original picture of the object. In some implementations, the counterfeit estimation system may set the counterfeit score based on a quantity of matching images found in the web search, with a greater quantity of matches being associated with a higher counterfeit likelihood and a lower quantity of matches being associated with a lower counterfeit likelihood.

Additionally, or alternatively, the image analysis may include a comparison of one or more features of the object, recognized from the image, to one or more features of an authentic object corresponding to the object. For example, the counterfeit estimation system may store an image of an authentic version of the object (or multiple images, such as images from different angles or vantage points), which may be known to be authentic and may be marked in a database as authentic. The counterfeit estimation system may detect one or more features of the image from the web page, such as a portion of the image that corresponds to a particular portion of the object, and may compare those features to corresponding features in the image of the authentic version of the object. If the feature(s) from the image from the web page match the corresponding features in the image of the authentic version of the object, then the counterfeit estimation system may set a counterfeit score to a low value, indicative of a low likelihood that the object is counterfeit because the object matches a known authentic object. In some implementations, the counterfeit estimation system may set the counterfeit score based on a quantity of matching features, with a greater quantity of matches being associated with a lower counterfeit likelihood and a lower quantity of matches being associated with a higher counterfeit likelihood.

As shown by reference number 150, the text analysis may include a search of the text (e.g., text 120 of the web page, as described above) for one or more keywords. For example, the text analysis may include a search of the text for a first set of keywords, sometimes referred to herein as a set of negative keywords. A keyword may include a word, a phrase, or a string of characters. The set of negative keywords may include one or more keywords indicative of a counterfeit object, such as “counterfeit,” “fake,” “inauthentic,” “CF,” “unbranded,” “knockoff,” or the like (or “nobody will know the difference,” as shown in FIG. 1B). If the text includes a negative keyword, then the counterfeit estimation system may set a counterfeit score to a high value, indicative of a high likelihood that the object is counterfeit. In some implementations, the counterfeit estimation system may set the counterfeit score based on a quantity of negative keywords found in the text of the web page, with a greater quantity of negative keywords being associated with a higher counterfeit likelihood and a lower quantity of negative keywords being associated with a lower counterfeit likelihood.

Additionally, or alternatively, the text analysis may include a search of the text for a second set of keywords, sometimes referred to herein as a set of positive keywords. The set of positive keywords may include one or more keywords indicative of an authentic object, such as “legitimate,” “authentic,” “real,” “original,” or the like. If the text includes a positive keyword, then the counterfeit estimation system may set a counterfeit score to a low value, indicative of a low likelihood that the object is counterfeit. In some implementations, the counterfeit estimation system may set the counterfeit score based on a quantity of positive keywords found in the text of the web page, with a greater quantity of positive keywords being associated with a lower counterfeit likelihood and a lower quantity of positive keywords being associated with a higher counterfeit likelihood. In some implementations, the set of negative keywords and/or the set of positive keywords are stored in memory of the counterfeit estimation system.

Additionally, or alternatively, the text analysis may include performing natural language processing to determine an intent associated with the text. For example, natural language processing may be used to determine that the phrase “It looks so similar to the actual toy” is indicative of a counterfeit object, and may set a high counterfeit score as a result. Additionally, or alternatively, the text analysis may include determining a text length of the text (e.g., a word count, a character count, a length of a description of an object, or the like). In some implementations, the counterfeit estimation system may set the counterfeit score based on the text length, with a longer text length being associated with a higher counterfeit likelihood and a shorter text length associated with a lower counterfeit likelihood. Alternatively, a longer text length may be associated with a lower counterfeit likelihood and a shorter text length associated with a higher counterfeit likelihood. Alternatively, a range of text lengths may be associated with a lower counterfeit likelihood, and a text length outside of the range may be associated with a higher counterfeit likelihood.

Additionally, or alternatively, the text analysis may include a comparison of a price, indicated in the text, to one or more other prices corresponding to the object. In some implementations, the one or more other prices may include a price or a range of prices stored by the counterfeit estimation system and known to be authentic prices (e.g., associated with verified purchases, a manufacturer's suggested retail price (MSRP), or the like). Additionally, or alternatively, the one or more prices may include one or more prices obtained from a web search associated with the object. For example, the counterfeit estimation system may perform a web search, such as a shopping search, using the object identifier (e.g., “Transformers Optimus Prime”), and may identify one or more prices based on performing the web search. If the price from the web page matches or is within a threshold amount of a price identified based on performing the web search (e.g., a price other than the price from the web page, which may be determined based on a URL of the web page), or if the price from the web page matches a threshold quantity of prices identified based on performing the web search, then the counterfeit estimation system may set a counterfeit score to a low value, indicative of a low likelihood that the object is counterfeit because the price is similar to other prices being charged for the object. If the price is different from a price identified based on performing the web search by a threshold amount, then the counterfeit estimation system may set a counterfeit score to a high value, indicative of a high likelihood that the object is counterfeit because the price is different from other prices being charged for the object. In some implementations, the counterfeit estimation system may set the counterfeit score based on a number of standard deviations between the price obtained from the website and one or more other prices.

As shown by reference number 155, the entity analysis may be based on an entity profile associated with the entity in connection with the platform (e.g., a web platform). For example, an entity that offers the object for sale may have an entity profile associated with a platform that hosts a marketplace via which the object is offered for sale. The entity profile may indicate, for example, an entity name (e.g., a merchant name or username associated with the entity on the platform), a domain name associated with the entity, a location associated with the entity (sometimes called an entity location, such as a geographic location or headquarters of an entity), a volume of transactions associated with the entity, a length of time that the entity has had an account associated with the web page or the platform (sometimes called an entity account duration), a transaction history associated with the entity, and/or a rating of the entity (sometimes called an entity rating). In some implementations, the counterfeit estimation may request or receive the entity profile from a data source associated with the platform (e.g., a database that stores entity profiles in connection with the platform).

In some implementations, the counterfeit estimation system may use one or more elements of the entity profile (sometimes called an entity profile element) to determine a counterfeit estimation for the object. For example, the counterfeit estimation system may set a counterfeit score based on a value of an entity profile element (or multiple values corresponding to multiple entity profile elements). For example, different locations may be associated with different counterfeit scores (e.g., with this relationship being stored in a database), different volumes of transactions may be associated with different counterfeit scores (e.g., a high volume associated with a low counterfeit score and a low volume associated with a high counterfeit score), different entity account durations may be associated with different counterfeit scores (e.g., a long duration associated with a low counterfeit score and a short duration associated with a high counterfeit score), and/or different entity ratings may be associated with different counterfeit scores (e.g., a low rating associated with a high counterfeit score and a high rating associated with a low counterfeit score).

As shown by reference number 160, the platform analysis may be based on a platform profile associated with the platform via which the object is offered for sale. The platform profile may include, for example, information about historical listings on the platform (e.g., web pages and user interface information for those web pages) and/or counterfeit estimations for historical listings. In some implementations, the counterfeit estimation system may request or receive the platform profile from a data source associated with the platform (e.g., a database that stores a platform profile in connection with the platform). In some implementations, the counterfeit estimation system may determine an aggregate counterfeit score for the platform based on historical counterfeit estimations, such as by determining an average counterfeit score, a quantity of counterfeit objects sold via the platform, a ratio of counterfeit objects to authentic objects sold via the platform, or the like.

In some implementations, the counterfeit estimation system may use one or more machine learning techniques to determine a counterfeit estimation for the object. For example, the counterfeit estimation system may determine the image-based counterfeit estimation described above (e.g., in connection with reference number 145) by applying a trained machine learning model to the user interface information (specifically, the image, but also other user interface information in some implementations). In some implementations, the machine learning model may be trained using historical data about images included on web pages known to offer a counterfeit object (or an authentic object) for sale, return data indicating objects that were returned (e.g., after a sale) and corresponding images on web pages via which those objects were sold, ratings (e.g., of entities or objects) that are indicative of counterfeit objects and corresponding images on web pages via which those objects were sold, and/or insurance claims associated with objects (e.g., after a sale) and corresponding images on web pages via which those objects were sold.

Additionally, or alternatively, the counterfeit estimation system may determine the text-based counterfeit estimation described above (e.g., in connection with reference number 150) by applying a trained machine learning model to the user interface information (specifically, the text, but also other user interface information in some implementations). In some implementations, the machine learning model may be trained using historical data about text included on web pages known to offer a counterfeit object (or an authentic object) for sale, return data indicating objects that were returned (e.g., after a sale) and corresponding text on web pages via which those objects were sold, ratings (e.g., of entities or objects) that are indicative of counterfeit objects and corresponding text on web pages via which those objects were sold, and/or insurance claims associated with objects (e.g., after a sale) and corresponding text on web pages via which those objects were sold.

Additionally, or alternatively, the counterfeit estimation system may determine the entity-based counterfeit estimation described above (e.g., in connection with reference number 155) by applying a trained machine learning model to the user interface information (specifically, the entity, but also other user interface information in some implementations) and/or the entity profile. In some implementations, the machine learning model may be trained using historical data about entities known to sell a counterfeit object (or an authentic object) or offer a counterfeit object (or an authentic object) for sale, return data indicating objects that were returned (e.g., after a sale) and corresponding entities that sold those objects, ratings (e.g., of entities or objects) that are indicative of counterfeit objects, and/or insurance claims associated with objects (e.g., after a sale) and corresponding entities that sold those objects. As another example, the counterfeit estimation system may determine the entity-based counterfeit estimation by applying a machine learning model to cluster entities into multiple clusters. The counterfeit estimation system may determine the entity-based counterfeit estimation for an entity based on a cluster in which that entity is classified or categorized.

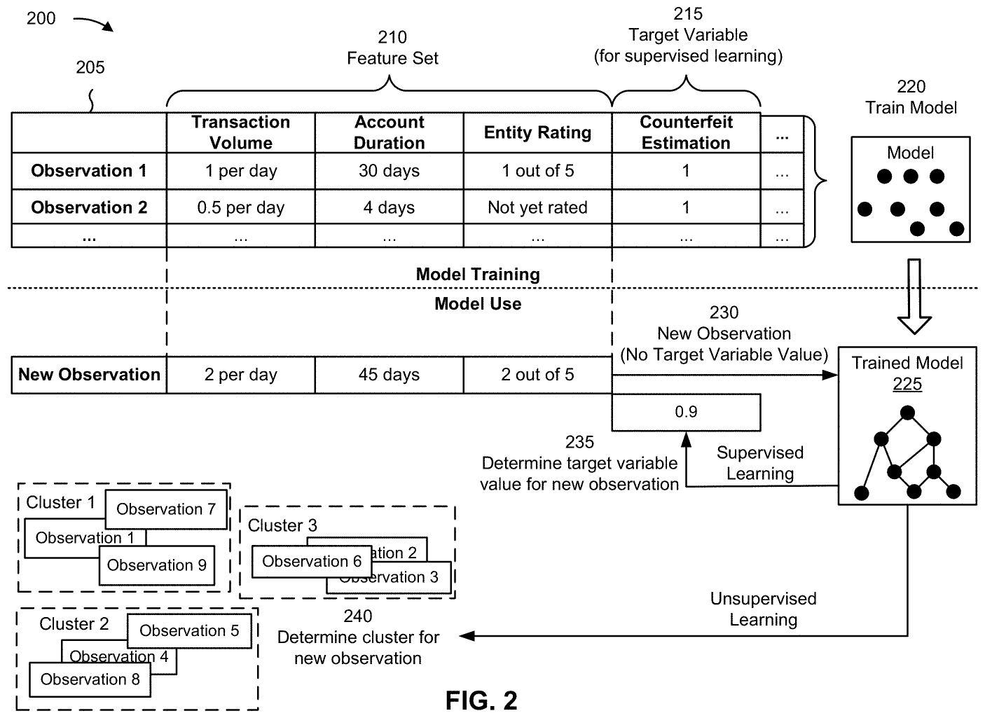

Additionally, or alternatively, the counterfeit estimation system may determine the platform-based counterfeit estimation described above (e.g., in connection with reference number 160) by applying a trained machine learning model to the user interface information (specifically, the platform, but also other user interface information in some implementations) and/or the platform profile. In some implementations, the machine learning model may be trained using historical data about platforms via which counterfeit objects (or authentic objects) were sold or offered for sale, return data indicating objects that were returned (e.g., after a sale) and corresponding platforms via which those objects were sold, ratings (e.g., of entities or objects) on the platform that are indicative of counterfeit objects, and/or insurance claims associated with objects (e.g., after a sale) and corresponding platforms via which those objects were sold. As another example, the counterfeit estimation system may determine the platform-based counterfeit estimation by applying a machine learning model to cluster platforms into multiple clusters. The counterfeit estimation system may determine the platform-based counterfeit estimation for a platform based on a cluster in which that platform is classified or categorized. Additional details regarding training and using a machine learning model are described below in connection with FIG. 2.

In some implementations, the counterfeit estimation system may determine multiple counterfeit scores using one or more of the above analysis techniques. The counterfeit estimation system may combine the multiple counterfeit scores to generate an aggregate counterfeit estimation indicative of a likelihood that an object is counterfeit. For example, the counterfeit estimation system may determine a first estimation (e.g., an image-based counterfeit estimation) that the object is counterfeit based on performing the image analysis, may determine a second estimation (e.g., a text-based counterfeit estimation) that the object is counterfeit based on performing the text analysis, may determine a third estimation (e.g., an entity-based counterfeit estimation) that the object is counterfeit based on performing the entity analysis, and/or may determine a fourth estimation (e.g., a platform-based counterfeit estimation) that the object is counterfeit based on performing the platform analysis. The counterfeit estimation system may combine two or more of the image-based counterfeit estimation, the text-based counterfeit estimation, the entity-based counterfeit estimation, or the platform-based counterfeit estimation to generate the aggregate counterfeit estimation. The aggregate counterfeit estimation may be an average of the individual estimations, a weighted average of the individual estimations (e.g., with different weights being applied to different individual estimations), a sum of the individual estimations, or some other function applied to the individual estimations.

As shown in FIG. 1C, and by reference number 165, the counterfeit estimation system may transmit, to the client device, presentation information. In some implementations, the presentation information may include or identify the counterfeit estimation (e.g., shown as 90% in FIG. 1C). Additionally, or alternatively, the presentation information may include information (e.g., a link or a URL) that identifies an alternative web page via which an alternative object is offered for sale. The alternative object may be similar to, the same as, a different version of, or the same type of object as the object on the original web page (e.g., that triggered the counterfeit estimation), but may have a lower counterfeit estimation, and thus a lower likelihood of being counterfeit.

In some implementations, the counterfeit estimation system may identify the alternative web page based on web data, such as by performing a web search using the search query associated with the object (e.g., “Transformers Optimus Prime” in example 100). The counterfeit estimation system may identify an alternative web page based on the search query (e.g., included in search results), and may analyze the alternative web page to determine a corresponding counterfeit estimation for the alternative web page, in a similar manner as described above for the original web page. If the counterfeit estimation for the alternative web page indicates a lower likelihood of the alternative object being counterfeit than the original object (e.g., on the original web page), then the counterfeit estimation system may include the link or URL to the alternative web page in the presentation information. In some implementations, the counterfeit estimation system may determine counterfeit estimations for multiple alternative web pages, and may include links or URLs to multiple alternative web pages (e.g., with the lowest counterfeit estimations) in the presentation information. In some implementations, the counterfeit estimation system may identify a single web page with the lowest counterfeit estimation among the multiple web pages, and may include a link or URL to that single web page in the presentation information.

As further shown in FIG. 1C, the presentation information may include information about a financial product, such as insurance information. In some implementations, the counterfeit estimation system may identify a recommended financial product, such as an insurance product, based on the counterfeit estimation, the object, and/or a price of the object. For example, the counterfeit estimation system may determine a cost of insurance (e.g., a lump sum cost or a recurring cost) based on the counterfeit estimation and the price of the object. A higher counterfeit estimation, indicative of a higher likelihood that the object is counterfeit, may be associated with a higher insurance cost. A lower counterfeit estimation, indicative of a lower likelihood that the object is counterfeit, may be associated with a lower insurance cost. The counterfeit estimation system may transmit information that identifies the recommended financial product and/or a link associated with the financial product (e.g., a link to obtain additional information about insurance for the object, a link to purchase insurance for the object, or the like) to the client device.

In some implementations, the counterfeit estimation system may determine and/or transmit the insurance information and/or information associated with the alternative web page only if the counterfeit estimation satisfies a threshold (e.g., greater than or equal to a 40% likelihood of being counterfeit, greater than or equal to a 50% likelihood of being counterfeit, greater than or equal to a 60% likelihood of being counterfeit, and so on). In this way, the counterfeit estimation system may conserve computing resources and network resources that would otherwise be used to determine and/or transmit the insurance information and/or the information associated with the alternative web page. Additionally, or alternatively, if the counterfeit estimation satisfies a threshold, then the counterfeit estimation system may transmit a notification, that identifies the web page, the entity, and/or other user interface information, to a device associated with the platform to notify an owner or operator of the platform of the likely counterfeit object. Additionally, or alternatively, the counterfeit estimation system may include, in the presentation information, a link via which the web page and/or entity can be reported in connection with the platform.

As shown by reference number 170, based on receiving the presentation information from the counterfeit estimation system, the client device may present (e.g., via the browser extension) a user interface for display based on the presentation information. For example, the information presented for display may include the presentation information, such as an indication of the counterfeit estimation of the original object associated with the original web page (e.g., 90% in FIG. 1C), a link to an alternative web page via which an alternative object can be purchased, a counterfeit estimation for the alternative object (e.g., 5% in FIG. 1C), a link to a web page that provides insurance information or via which insurance to cover the object can be purchased, and/or a link to report the web page and/or the entity to the platform.

In some implementations, the client device may insert code into a document object model (DOM) of a user interface being presented for display by the client device. The code may be generated by the client device based on the presentation information, and may cause the counterfeit information (and/or other information, as described above) to be provided for presentation via the user interface. The client device may provide the user interface for presentation based on inserting the code into the DOM.

Although techniques are described herein for performing a counterfeit estimation for an object that is associated with a web page, these techniques can be applied to images of objects obtained in another manner. For example, a user may use the client device (e.g., a phone) to capture an image (e.g., using a camera) of an object, and the client device may transmit that image to the counterfeit estimation system, which may determine a counterfeit estimation as described elsewhere herein and transmit the counterfeit estimation (and/or other information) to the client device for display (e.g., in an application, via an augmented reality overlay of a user interface that includes an image of the object that is being captured, or the like). As another example, the counterfeit estimation system may obtain the user interface information described herein from an email account (e.g., by receiving authorization from the client device to monitor an email account and monitoring emails, such as by monitoring an email server).

Using the computer-based techniques described herein to assist with counterfeit object detection, such as by using image analysis to analyze an image of an object to determine whether the object is counterfeit or legitimate, can improve the reliability with which counterfeit objects can be detected. These techniques can improve the accuracy and reliability of counterfeit object detection using image analysis and/or other counterfeit object detection techniques. Also, some techniques described herein use machine learning to improve the accuracy and reliability of counterfeit object detection.

As indicated above, FIGS. 1A-1C are provided as an example. Other examples may differ from what is described with regard to FIGS. 1A-1C.

FIG. 2 is a diagram illustrating an example 200 of training and using a machine learning model in connection with counterfeit object detection. The machine learning model training and usage described herein may be performed using a machine learning system. The machine learning system may include or may be included in a computing device, a server, a cloud computing environment, or the like, such as the counterfeit estimation system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the client device, the counterfeit estimation system, and/or one or more data sources, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the client device, the counterfeit estimation system, and/or one or more data sources. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of transaction volume, a second feature of account duration, a third feature of entity rating, and so on. As shown, for a first observation, the first feature may have a value of 1 transaction per day, the second feature may have a value of 30 days, the third feature may have a value of 1 out of 5, and so on. These features and feature values are provided as examples, and may differ in other examples. For example, the feature set may include any information included in an entity profile, a platform profile, user interface information, or other information described elsewhere herein as being used to determine a counterfeit estimation.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, or labels) and/or may represent a variable having a Boolean value. A target variable may be associated with a target variable value, and a target variable value may be specific to an observation. In example 200, the target variable is a counterfeit estimation, which has a value of 1 for the first observation. For example, the entity may be associated with a return of a counterfeit object, may be marked in a database as being associated with counterfeit objects, may be associated with an insurance claim for a counterfeit object, or the like. Based on this information, the target variable of the training data may be set to 1 to indicate a 100% likelihood that the entity sold a counterfeit object.

The feature set and target variable described above are provided as examples, and other examples may differ from what is described above. For example, a machine learning model may be trained and used to determine an image-based counterfeit estimation, a text-based counterfeit estimation, an entity-based counterfeit estimation (shown in FIG. 2), and/or a platform-based counterfeit estimation, as described elsewhere herein. Additionally, or alternatively, a machine learning model may be used to determine a counterfeit estimation based on features used to determine any combination of an image-based counterfeit estimation, a text-based counterfeit estimation, an entity-based counterfeit estimation, and/or a platform-based counterfeit estimation, as described elsewhere herein.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of 2 transactions per day, a second feature of 45 days, a third feature of 2 out of 5, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of 0.9 for the target variable of counterfeit estimation for the new observation, as shown by reference number 235. This may indicate a 90% likelihood that an object offered for sale by the entity is counterfeit. Based on this prediction (e.g., the counterfeit estimation being greater than a threshold), the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation not to purchase the object, a recommendation to purchase insurance for the object, or the like. The first automated action may include, for example, transmitting presentation information that includes the counterfeit estimation and other information, such as insurance information or an alternative web page.

As another example, if the machine learning system were to predict a value of 0.2 (e.g., below a threshold) for the target variable of counterfeit estimation, then the machine learning system may provide a second (e.g., different) recommendation (e.g., a recommendation to purchase the object or a recommendation not to purchase insurance for the object) and/or may perform or cause performance of a second (e.g., different) automated action (e.g., transmitting presentation information that includes only the counterfeit estimation, and not insurance information and/or information associated with an alternative web page).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., entities with a high likelihood of selling counterfeit objects), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above. As another example, if the machine learning system were to classify the new observation in a second cluster (e.g., entities with a high likelihood of selling counterfeit objects), then the machine learning system may provide a second (e.g., different) recommendation and/or may perform or cause performance of a second (e.g., different) automated action, such as those described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In this way, the machine learning system may apply a rigorous and automated process to detect and/or estimate a likelihood of counterfeit objects. The machine learning system enables recognition and/or identification of tens, hundreds, thousands, or millions of features and/or feature values for tens, hundreds, thousands, or millions of observations, thereby increasing accuracy and consistency and reducing delay associated with counterfeit objection estimation or detection relative to requiring computing resources to be allocated for tens, hundreds, or thousands of operators to manually detect or estimate a likelihood of counterfeit objects using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a client device 310 (e.g., which may execute a web browser 320 and a browser extension 330), a web server 340, an extension server 350, a counterfeit estimation system 360, one or more data sources 370, and a network 380. Devices of environment 300 may interconnect via wired connections, wireless connections, or a combination of wired and wireless connections.

Client device 310 includes a device that supports web browsing. For example, client device 310 may include a computer (e.g., a desktop computer, a laptop computer, a tablet computer, and/or a handheld computer), a mobile phone (e.g., a smart phone), a television (e.g., a smart television), an interactive display screen, and/or a similar type of device. Client device 310 may host a web browser 320 and/or a browser extension 330 installed on and/or executing on the client device 310.

Web browser 320 includes an application, executing on client device 310, that supports web browsing. For example, web browser 320 may be used to access information on the World Wide Web, such as web pages, images, videos, and/or other web resources. Web browser 320 may access such web resources using a uniform resource identifier (URI), such as a uniform resource locator (URL) and/or a uniform resource name (URN). Web browser 320 may enable client device 310 to retrieve and present, for display, content of a web page.

Browser extension 330 includes an application, executing on client device 310, capable of extending or enhancing functionality of web browser 320. For example, browser extension 330 may be a plug-in application for web browser 320. Browser extension 330 may be capable of executing one or more scripts (e.g., code, which may be written in a scripting language, such as JavaScript) to perform an operation in association with the web browser 320.

Web server 340 includes a device capable of serving web content (e.g., web documents, HTML, documents, web resources, images, style sheets, scripts, and/or text). For example, web server 340 may include a server and/or computing resources of a server, which may be included in a data center and/or a cloud computing environment. Web server 340 may process incoming network requests (e.g., from client device 310) using HTTP and/or another protocol. Web server 340 may store, process, and/or deliver web pages to client device 310. In some implementations, communication between web server 340 and client device 310 may take place using HTTP.

Extension server 350 includes a device capable of communicating with client device 310 to support operations of browser extension 330. For example, extension server 350 may store and/or process information for use by browser extension 330. As an example, extension server 350 may store a list of domains applicable to a script to be executed by browser extension 330. In some implementations, client device 310 may obtain the list (e.g., periodically and/or based on a trigger), and may store a cached list locally on client device 310 for use by browser extension 330.

The counterfeit estimation system 360 includes one or more devices capable of receiving, generating, storing, processing, providing, and/or routing information associated with detecting and/or estimating a likelihood of counterfeit objects, as described elsewhere herein. The counterfeit estimation system 360 may include a communication device and/or a computing device. For example, the counterfeit estimation system 360 may include a server, such as an application server, a client server, a web server, a database server, a host server, a proxy server, a virtual server (e.g., executing on computing hardware), or a server in a cloud computing system. In some implementations, the counterfeit estimation system 360 includes computing hardware used in a cloud computing environment.

The data source 370 includes one or more devices capable of receiving, generating, storing, processing, and/or providing information associated with detecting and/or estimating a likelihood of counterfeit objects, as described elsewhere herein. The data source 370 may include a communication device and/or a computing device. For example, the data source 370 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 370 may communicate with one or more other devices of environment 300, as described elsewhere herein.

Network 380 includes one or more wired and/or wireless networks. For example, network 380 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to client device 310, web server 340, extension server 350, counterfeit estimation system 360, and/or data source 370. In some implementations, client device 310, web server 340, extension server 350, counterfeit estimation system 360, and/or data source 370 may include one or more devices 400 and/or one or more components of device 400. As shown in FIG. 4, device 400 may include a bus 410, a processor 420, a memory 430, an input component 440, an output component 450, and a communication component 460.

Bus 410 includes one or more components that enable wired and/or wireless communication among the components of device 400. Bus 410 may couple together two or more components of FIG. 4, such as via operative coupling, communicative coupling, electronic coupling, and/or electric coupling. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform one or more operations or processes described elsewhere herein.

Memory 430 includes volatile and/or nonvolatile memory. For example, memory 430 may include random access memory (RAM), read only memory (ROM), a hard disk drive, and/or another type of memory (e.g., a flash memory, a magnetic memory, and/or an optical memory). Memory 430 may include internal memory (e.g., RAM, ROM, or a hard disk drive) and/or removable memory (e.g., removable via a universal serial bus connection). Memory 430 may be a non-transitory computer-readable medium. Memory 430 stores information, instructions, and/or software (e.g., one or more software applications) related to the operation of device 400. In some implementations, memory 430 includes one or more memories that are coupled to one or more processors (e.g., processor 420), such as via bus 410.

Input component 440 enables device 400 to receive input, such as user input and/or sensed input. For example, input component 440 may include a touch screen, a keyboard, a keypad, a mouse, a button, a microphone, a switch, a sensor, a global positioning system sensor, an accelerometer, a gyroscope, and/or an actuator. Output component 450 enables device 400 to provide output, such as via a display, a speaker, and/or a light-emitting diode. Communication component 460 enables device 400 to communicate with other devices via a wired connection and/or a wireless connection. For example, communication component 460 may include a receiver, a transmitter, a transceiver, a modem, a network interface card, and/or an antenna.

Device 400 may perform one or more operations or processes described herein. For example, a non-transitory computer-readable medium (e.g., memory 430) may store a set of instructions (e.g., one or more instructions or code) for execution by processor 420. Processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, processor 420 may be configured to perform one or more operations or processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

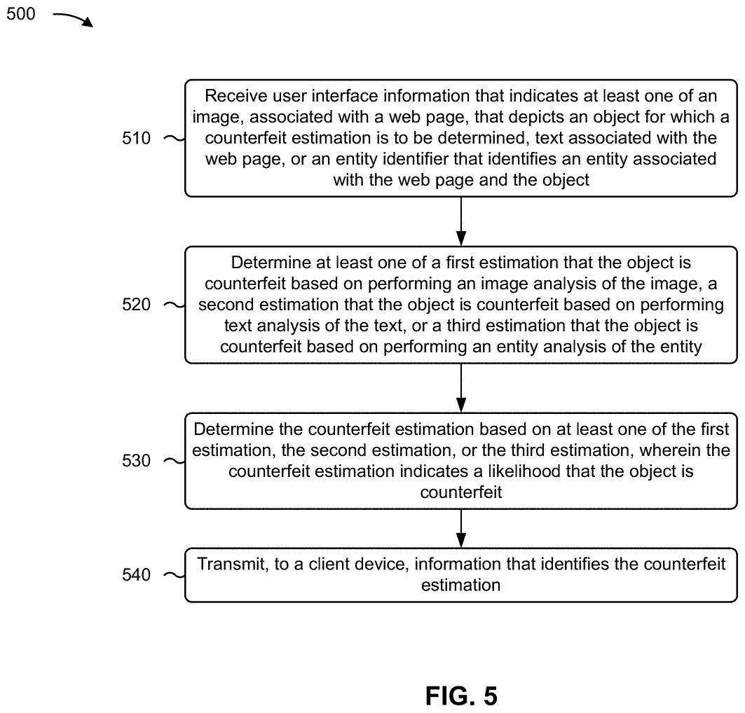

FIG. 5 is a flowchart of an example process 500 associated with counterfeit object detection. In some implementations, one or more process blocks of FIG. 5 may be performed by a system (e.g., counterfeit estimation system 360). In some implementations, one or more process blocks of FIG. 5 may be performed by another device or a group of devices separate from or including the system. Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving user interface information that indicates at least one of: an image, associated with a web page, that depicts an object for which a counterfeit estimation is to be determined, text associated with the web page, or an entity identifier that identifies an entity associated with the web page and the object (block 510). As further shown in FIG. 5, process 500 may include determining at least one of: a first estimation that the object is counterfeit based on performing an image analysis of the image, a second estimation that the object is counterfeit based on performing text analysis of the text, or a third estimation that the object is counterfeit based on performing an entity analysis of the entity (block 520). As further shown in FIG. 5, process 500 may include determining the counterfeit estimation based on at least one of the first estimation, the second estimation, or the third estimation, wherein the counterfeit estimation indicates a likelihood that the object is counterfeit (block 530). As further shown in FIG. 5, process 500 may include transmitting, to a client device, information that identifies the counterfeit estimation (block 540).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

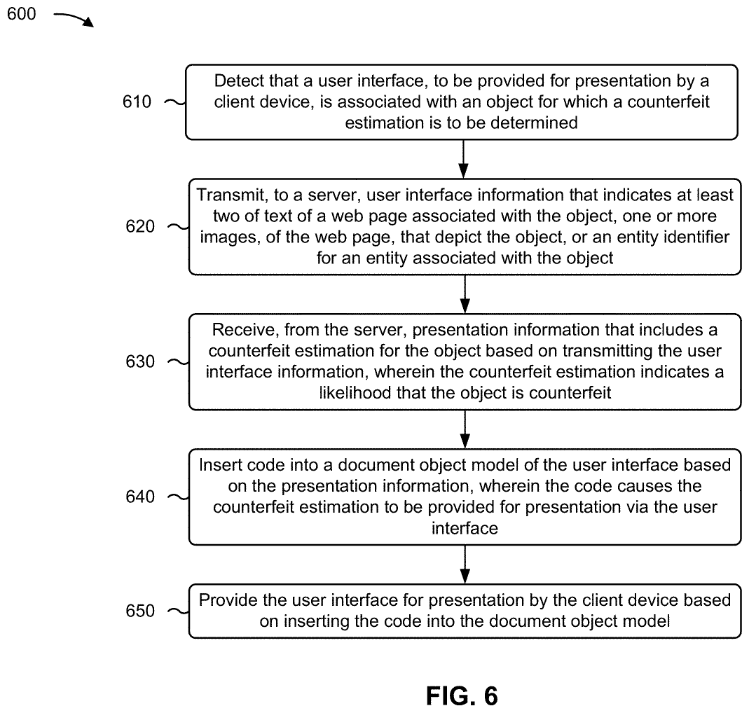

FIG. 6 is a flowchart of an example process 600 associated with counterfeit object detection. In some implementations, one or more process blocks of FIG. 6 may be performed by a client device (e.g., client device 310). In some implementations, one or more process blocks of FIG. 6 may be performed by another device or a group of devices separate from or including the client device. Additionally, or alternatively, one or more process blocks of FIG. 6 may be performed by one or more components of device 400, such as processor 420, memory 430, input component 440, output component 450, and/or communication component 460.

As shown in FIG. 6, process 600 may include detecting that a user interface, to be provided for presentation by a client device, is associated with an object for which a counterfeit estimation is to be determined (block 610). As further shown in FIG. 6, process 600 may include transmitting, to a server, user interface information that indicates at least two of: text of a web page associated with the object, one or more images, of the web page, that depict the object, or an entity identifier for an entity associated with the object (block 620). As further shown in FIG. 6, process 600 may include receiving, from the server, presentation information that includes a counterfeit estimation for the object based on transmitting the user interface information, wherein the counterfeit estimation indicates a likelihood that the object is counterfeit (block 630). As further shown in FIG. 6, process 600 may include inserting code into a document object model of the user interface based on the presentation information, wherein the code causes the counterfeit estimation to be provided for presentation via the user interface (block 640). As further shown in FIG. 6, process 600 may include providing the user interface for presentation by the client device based on inserting the code into the document object model (block 650).

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for using image analysis to detect counterfeit objects, comprising:
one or more memories; and
one or more processors, communicatively coupled to the one or more memories, configured to:
receive, from a client device, user interface information that indicates an image of an object for which a counterfeit estimation is to be determined;
perform an image analysis on the image, wherein the image analysis includes at least one of:
a comparison of the image and one or more other images obtained from a web search associated with the object, or
a comparison of one or more features of the object, recognized from the image, to one or more features of an authentic object corresponding to the object;
determine the counterfeit estimation based on performing the image analysis, wherein the counterfeit estimation indicates a likelihood that the object is counterfeit; and
transmit, to the client device, information that identifies the counterfeit estimation.

2. The system of claim 1, wherein the user interface information further includes text from a user interface that includes the image; and
wherein the one or more processors are further configured to:
perform text analysis on the text, wherein the text analysis includes at least one of:
a search of the text for one or more keywords, or
a comparison of a price, indicated in the text, to one or more other prices corresponding to the object; and
wherein the counterfeit estimation is determined further based on performing the text analysis.

3. The system of claim 1, wherein the user interface information identifies an entity associated with the object; and
wherein the one or more processors are further configured to:
perform an entity analysis based on an entity profile associated with the entity in connection with a web platform associated with the object; and
wherein the counterfeit estimation is determined further based on performing the entity analysis.

4. The system of claim 1, wherein the one or more processors are further configured to:
determine a first estimation that the object is counterfeit based on performing the image analysis;
determine a second estimation that the object is counterfeit based on performing text analysis based on text included in the user interface information;
determine a third estimation that the object is counterfeit based on performing an entity analysis based on an entity, associated with the object, indicated in the user interface information; and
determine the counterfeit estimation based on the first estimation, the second estimation, and the third estimation.

5. The system of claim 4, wherein at least one of the first estimation, the second estimation, or the third estimation is determined by applying a trained machine learning model to at least one of the image, the text, or the entity.

6. The system of claim 1, wherein the one or more processors are further configured to:
identify, based on web data, a web page associated with an alternative object, associated with the object, that has a lower likelihood of being counterfeit compared to the object; and
transmit, to the client device, a link to the web page.

7. The system of claim 1, wherein the one or more processors are further configured to:
identify a recommended financial product based on the counterfeit estimation; and
transmit, to the client device, information that identifies the recommended financial product.

8. A method for detecting counterfeit objects, comprising:
receiving, by a system, user interface information that indicates at least one of:
an image, associated with a web page, that depicts an object for which a counterfeit estimation is to be determined,
text associated with the web page, or
an entity identifier that identifies an entity associated with the web page and the object;
determining, by the system, at least one of:
a first estimation that the object is counterfeit based on performing an image analysis of the image,
a second estimation that the object is counterfeit based on performing text analysis of the text, or
a third estimation that the object is counterfeit based on performing an entity analysis of the entity;
determining, by the system, the counterfeit estimation based on at least one of the first estimation, the second estimation, or the third estimation, wherein the counterfeit estimation indicates a likelihood that the object is counterfeit; and
transmitting, by the system and to a client device, information that identifies the counterfeit estimation.

9. The method of claim 8, further comprising determining the first estimation based on performing the image analysis, wherein the image analysis includes at least one of:
a comparison of the image and one or more other images obtained from a web search associated with the object, or
a comparison of one or more features of the object, recognized from the image, to one or more features of an authentic object corresponding to the object; and
wherein the counterfeit estimation is determined based on at least the first estimation.

10. The method of claim 8, further comprising determining the second estimation based on performing the text analysis, wherein the text analysis includes at least one of:
a search of the text for one or more keywords,
a comparison of a price, indicated in the text, to an one or more other prices corresponding to the object; and
wherein the counterfeit estimation is determined based on at least the second estimation.

11. The method of claim 8, further comprising determining the third estimation based on performing the entity analysis, wherein the entity analysis is based on an entity profile associated with the entity in connection with the web page; and
wherein the counterfeit estimation is determined based on at least the third estimation.

12. The method of claim 11, wherein the entity profile indicates at least one of a domain name associated with the entity, a location associated with the entity, a volume of transactions associated with the entity, a length of time that the entity has had an account associated with the web page, or a rating of the entity.

13. The method of claim 8, wherein one or more of the first estimation, the second estimation, or the third estimation is determined based on one or more machine learning models, wherein the one or more machine learning models are trained based on historical information that indicates at least one of:
returns of objects and corresponding web pages associated with those objects, or
ratings associated with objects and corresponding web pages associated with those objects.

14. The method of claim 13, wherein the one or more machine learning models are further trained based on insurance claims associated with objects.

15. The method of claim 8, further comprising determining at least two of the first estimation, the second estimation, or the third estimation; and
wherein the counterfeit estimation is determined based on the at least two of the first estimation, the second estimation, or the third estimation.

16. The method of claim 8, further comprising:
determining the first estimation based on a first machine learning model;
determining the second estimation based on a second machine learning model;
determining the third estimation based on a third machine learning model; and
wherein the counterfeit estimation is determined based on a combination of the first estimation, the second estimation, and the third estimation.

17. A non-transitory computer-readable medium storing a set of instructions for triggering a counterfeit estimation and presenting the counterfeit estimation via a user interface, the set of instructions comprising:
one or more instructions that, when executed by one or more processors of a client device, cause the client device to:
detect that the user interface, to be provided for presentation by the client device, is associated with an object for which the counterfeit estimation is to be determined;
transmit, to a server, user interface information that indicates at least two of:
text of a web page associated with the object,
one or more images, of the web page, that depict the object, or
an entity identifier for an entity associated with the object;
receive, from the server, presentation information that includes a counterfeit estimation for the object based on transmitting the user interface information, wherein the counterfeit estimation indicates a likelihood that the object is counterfeit;
insert code into a document object model of the user interface based on the presentation information, wherein the code causes the counterfeit estimation to be provided for presentation via the user interface; and
provide the user interface for presentation by the client device based on inserting the code into the document object model.

18. The non-transitory computer-readable medium of claim 17, wherein the one or more instructions, that cause the client device to detect that the user interface is associated with the object for which the counterfeit estimation is to be determined, cause the client device to:
determine that a uniform resource locator of the user interface includes a string that matches a stored string associated with a domain name of the web page, or
determine that the user interface includes information that indicates an offer for sale of the object.

19. The non-transitory computer-readable medium of claim 17, wherein the presentation information includes a link to purchase insurance for the object, wherein a cost of the insurance is based on the counterfeit estimation.

20. The non-transitory computer-readable medium of claim 17, wherein the presentation information indicates a web page via which an alternative object, associated with the object, can be purchased, wherein the alternative object has a lower likelihood of being counterfeit compared to the object.
